(19) United States
(12) Patent Application Publication
(10) Pub. No.: US 2006/0168261 A1
(43) Pub. Date: Jul. 27, 2006

(54) Radio communication interface module, and its use in a device reading, processing, transmitting and operating on a bar code

(76) Inventors: Thomas Serval, Neuilly sur Seine (FR); Olivier Giroud, Neuillly Sur Seine (FR); Sylvain Gommier, Paris (FR)

Correspondence Address: YOUNG & THOMPSON, 745 SOUTH 23RD STREET, 2ND FLOOR, ARLINGTON, VA, 22202, US

(21) Appl. No.: 10/474,185

(22) PCT Filed: Apr. 5, 2002
(86) PCT No.: PCT/FR02/01202

§ 371 Date: Sep. 7, 2004

(30) Foreign Application Priority Data
Apr. 5, 2001 (FR) 01/04659

(51) Int. Cl. G06F 15/16

(52) U.S. Cl. 709/230

(57) ABSTRACT

A two-way radio communication interface module based on a predefined protocol for at least a user application, the module includes at least a radio circuit for transmitting and receiving digital signals and at least a programmable circuit with a radio microcontroller for managing the radio circuit. The radio microcontroller includes a software stack consisting of a first part called protocol stack topped by a second part called applicative abstraction stack, the software stack enabling adaptation based on the protocol between the digital signals and the data and instructions of the application, the applicative abstraction stack enabling at least the translation of the data and instructions of the application into data and instructions based on the protocol for processing in the protocol stack.

This invention relates to a radiocommunication module interface, a device, applications whereof a method for reading, processing, transmitting and using a barcode such that the method implements the module in a stand-alone barcode reader with radio link. The invention may be implemented generically in all the hardware and software applications including a radio link and, also, implementation more specifically in a particular application in the field of business promotion, of commerce and more generally of data exchange on a computer network with pieces of equipment capable of processing hypermedia data such as text, image, sound and/or video.

Barcode type identification graphic codes are known and largely used due to the robustness of their reading and decoding. Several encoding standards have been defined as well as regards the one-dimension as the two-dimension barcodes.

These codes are read by electronic apparatuses including an optical reading head. According to the barcode scanning method and the type of optical reading head implemented, one has two large types of apparatus: the contact reading apparatuses which require physical displacement between the optical reading head and the support whereon is provided the barcode and the apparatuses capable of operating without any relative displacement, the scanning being obtained by mechanical methods (revolving mirror for example), and/or electronic methods (matrix detector for example). For the latter apparatus, diverse technologies may be implemented but in all cases, these are apparatuses more complex and costly to be made than the apparatuses of the first type whereof the reading pen which is one of the simplest apparatuses to be made since it only includes a static optical sensor and whereof the scanning of the barcode for reading lecture is performed by the user.

The reading pens known according to the state of the art are generally linked by an electric cable to an external electronic box itself connected to the keyboard of a computer. Such an optical pen is therefore not stand-alone and is not easier to manipulate since a cable links them to data-processing equipment. Moreover, this type of pen is of relatively high cost since the optical sensor includes moreover an optical element which is very hard, sapphire for example, and which may sustain repeated frictions on the support including the barcode while ensuring optical adaptation.

Besides in known applications, the barcodes which are read are essentially processed locally. For example in the applications of the payment check-out type, the data corresponding with the barcodes is processed at the check-out properly speaking to retrieve the price and, possibly, a description of the item, or in a local server of the business site connected to the set of check-outs in order to ensure also the management of the stock.

The object of the invention is to provide a radiocommunication hardware and software means in the form of a module which may adapt simply to any user application and, in a particular case, to a method wherein a computer network linking pieces of computer equipment capable of executing hypermedia applications implements data from reading barcodes in order to generate visual, acoustic actions and/or other, possibly interactive actions, on a piece of customer computer equipment in relation to a barcode reader. The term computer equipment in the context of the invention corresponds to any electronic device capable of processing hypermedia data and of being connected to the network computer and, for example, computer, micro-computer, personal assistant, telephone with WAP, GPRS, UMTS, etc. functionalities. Thanks to the particular application of the invention, the user may read a barcode with a reader and may receive quasi instantly a page of information regarding the object carrying the barcode, on any type of computer support connected to Internet (micro-computer, digital assistant, mobile telephone or others). The object may be any current consumption object (carrying then a barcode of type EAN or UPC) or any other type of object and, for example: visit cards, journal article, invoice, bank statement. The term barcode relates to a digital value or a character as well as several according to a standardised encoding or a corporate encoding (corporate barcode).

The invention relates therefore to an interface module for two-way radiocommunication according to a preset protocol for at least one user application having data and instructions to be communicated to an external device, the module including at least one radio electronic circuit for sending and receiving digital signals and at least one programmable electronic circuit with a radio microcontroller for managing the radio electronic circuit.

According to the invention, the radio microcontroller includes hardware means co-operating with software packages in the form of a software stack formed of a first section so-called protocol stack topped with a second section so-called applicative abstraction stack, the software stack enabling the adaptation according to the protocol between, on the one hand, the digital signals and, on the other hand, the data and instructions of the user application, the applicative abstraction stack enabling at least the translation of data and instructions of the user application into a corporate format into data and instructions according to the protocol for processing in the protocol stack, the module being a single hardware component also storing the user application in the form of a programme and ensuring its realisation in the radio microcontroller.

In various embodiments of the invention, the following means which might be combined according to all the technically possible combinations are employed:

the module is composed of a radio printed circuit including an aerial, the radio electronic circuit for sending and receiving in the form of a radio and of a base band integrated circuit and the programmable electronic management circuit in the form of a microcontroller with storage means,

the software operation of the module is divided into tasks performed according to priorities, the tasks associated with the management of the radio circuit having higher priority than the execution tasks of the user application,

the module includes moreover a second printed circuit interconnected with the radio printed circuit with at least one peripheral at least selected amongst:
a digital input with possibly a comparator for level or transition detection,
an analogue input with analogue-digital converter with possibly an analogue amplifier with programmable gain or non,
a digital output,
an analogue output with digital-analogue converter,
a voltage controllable regulator or converter,
an up/down counter,
a real time clock,
a charger circuit for battery,
a logic circuit,
a memory,
a specialised programmable logic circuit notably selected amongst a microprocessor, a microcontroller, a digital signal processor or a dedicated circuit, a portion at least of the user application in the form of a programme being then stored in said specialised programmable logic circuit and said specialised programmable logic circuit ensuring then its realisation,

the applicative abstraction stack capable moreover of comprising corporate software means for processing instructions for retrieving data from the peripheral and/or sending data to the peripheral,

the module includes a reprogrammable memory as well as means enabling reprogrammation of said memory on the basis of data received by radiocommunication,

the protocol is <<Bluetooth®>> or IEEE802.15.1,

the applicative abstraction stack ensures moreover and conversely the translation of information of the protocol stack towards the application;

the single component is an integrated circuit;

the module includes moreover at least one infrared two-way communication means and the applicative abstraction stack includes moreover software means for processing instructions and data for and of said infrared means;

the module includes a voltage regulator enabling to supply said module from a 220V/110V power supply socket, a battery or any other power source and the applicative abstraction stack includes moreover software means for processing instructions and data for and of said regulator;

the module includes moreover some memory intended for storing data;

the microcontroller is of a type comprised between 8 and 16 bits, pins included, with a frequency clock smaller than 200 KHz;

the microcontroller includes some memory enabling the execution of a user application programme, the programme application including a sequence of instructions and of data according to the corporate format;

the memory is a pre-programmed read-only memory;

the memory is a chargeable (reprogrammable) memory;

the chargeable memory is charged by the programme application at each beginning of said application in the module;

the chargeable memory is charged by the programme application once and for all at the manufacture of the module in said application;

the chargeable memory is charged by the programme application once and for all at the first start of said application in the module;

the programme application for charging is in a read-only memory external to the module;

the charging is performed by a wire-link, preferably a serial link;

the programme application for charging is in a computer means external to the module;

the charging is performed by the radio link of the module.

The invention relates also to a particular application of the module according to one or several of the previous features in the form of an interfacing device for two-way radiocommunication according to a preset protocol for at least one software user application and including a module according to any of the previous features, and according to which the device includes moreover within a single box, an electrochemical supply source, and at least one connector whereof the pins are linked with at least one interface of the module.

The invention relates also to a particular application of the module as such or in the device according to one or several of the previous features possibly combined for the realisation of an electronic apparatus including a software user application communicating by two-way radiocommunication according to a preset protocol and including a module according to any of the previous features.

In particular embodiments the apparatus is:

a apparatus which is a barcode reading pen of a support, the pen including at one end in an optical sensor a light source generating a light beam focused on the support and an optical detector intended to receive and convert the light reflected by the support into electric signals, the pen being stand-alone and including an internal electric power supply and the radiocommunication module interface, with a software stack according to the <<Bluetooth>>® protocol, the user application in the form of an operating programme including means for processing the electric signals of the optical detector, and interfacing means via the radiocommunication module ensuring at least the transmission of said barcodes according to said protocol to a data-processing equipment,

(the transmission of the barcodes corresponds to the characters that the user application has read)

as an alternative to the support, the barcodes correspond to a successive temporal chaining of dark and clear surfaces on a display screen,

a apparatus which is a reading pen with recognition of alpha-digital characters of a support, the pen including at one end in an optical sensor a light source generating a light beam focused on the support and an optical detector intended to receive and convert the light reflected by the support into electric signals, the pen being stand-alone and including an internal electric power supply and the radiocommunication module interface, with a software stack according to the <<Bluetooth®>> protocol, the user application in the form of an operating programme including means for processing the electric signals of the optical detector and recognising said characters, and interfacing means via the radiocommunication module ensuring at least the transmission of said characters according to said protocol to a data-processing equipment,

a apparatus which is a writing recognition reading pen, the pen including at least two accelerometers according to two axes X and Y corresponding to the writing plane and generating electric signals, the pen being stand-alone and including an internal electric power supply and the radiocommunication module interface, with a software stack according to the <<Bluetooth®>> protocol, the user application in the form of an operating programme including means for processing the electric signals of the optical detector and recognising the writing, and interfacing means via the radiocommunication module ensuring at least the transmission of said writing according to said protocol to a data-processing equipment,

(the transmission of the writing corresponds to the characters which the user application has read)

the writing recognition reading pen includes a means to detect according to an axis Z the resting time of the pen when writing on a support,

the means to detect the resting time is a contactor or an accelerometer,

an apparatus which is one of the previous pens and which does not includes any focusing tip made of hard matter,

an apparatus which is a mains electric supply socket controlled by radiocommunication,

the socket includes a voltage reducer for the power supply of the module, a controlled electronic on/off switch,

the reducer is selected amongst a chopping power supply, a static transformer power supply, a reducer capacitor power supply,

the on/off switch is selected amongst an electromagnetic relay, a triac, an electronic on/off switch with zero-crossover.

The invention relates also to a particular application of the module as such or in the device according to one or several of the previous features possibly combined in the form of a method for reading, processing, transmitting and using a barcode wherein:
the barcode is read with a reader including a radiocommunication module interface according to one or several of the previous features and optical reading means of the barcode optical reading head type generating electric signals relative to the bars,
said electric signals are processed in the interface module to generate digital and/or alpha-digital data,
said digital and/or alpha-digital data are associated a reader identifier in order to generate a chain of corporate data,
one transmits in real time the chain of corporate data to at least one customer equipment including at least one customer software to carry out a command understandable by said customer equipment,

In various modes of embodiment of the method the following means possibly combined are employed:

when customer equipment is not available for reception, one stores the chain of corporate data in a memory of the reader,

in the customer equipment one associates moreover with the chain of corporate data at least one piece of data of customer equipment type in order to build a computer address depending then on the barcode, on the reader identifier and on the data of equipment type,

one implements a correspondence table in order to associate a computer address with the chain of corporate data, possibly associated with at least one piece of data of customer equipment type, the correspondence table being situated in a computer server distinct from the customer equipment,

one implements a correspondence table in order to associate a computer address with the chain of corporate data, possibly associated with at least one piece of data of customer equipment type, the correspondence table being stored in the customer equipment,

(one also considers the case when the correspondence table is shared between the customer equipment and at least one routing server, and, for example in case when no correspondence is found in the table of the customer equipment, a distinct routing server is then used)

one stores the correspondence table in the customer equipment by selection according to a criterion in a global correspondence table situated in a computer server distinct from the customer equipment, the criterion including at least the reader identifier,

one implements a transmission means by electromagnetic waves in free space between the reader and the customer equipment with a communication protocol enabling at least to determine which are the pieces of customer equipment capable of communicating and, in case when several pieces of equipment were operational, said protocol enabling to select at least one of said pieces of equipment operational,

one encodes according to an encoding algorithm the digital and/or alpha-digital data before associating it with the reader identifier,

the computer address associated with the chain of corporate data is that of a computer server relaying an information request to another computer server,

the barcode is a corporate barcode;

the identifier of the reader is a single number on 48 bits of <<Bluetooth®>> address;

the identifier of the reader is a pre-programmed reader number during manufacture or programmed at a later stage;

the internal electric power supply source is of the rechargeable battery and/or electrochemical battery type;

the reader includes a means for providing its electric power supply by the pickup element of the user;

the reader includes a means for cutting its electric power supply by the pickup element of the user;

the means for providing the power supply is an electromechanical on/off switch of the push-button type, the power supply is cut off when the user releases said push-button;

the push-button is laid-out so that the user necessarily positions the reader (or pen) in a given orientation with respect to the barcode;

the given orientation is such that the reader (or pen) is substantially vertical when reading;

when the barcode is read without error, the power supply of the optical sensor is cut off but the radiocommunication module remains powered;

when the barcode is read without error, the power supply of the optical sensor is cut off but the radiocommunication module remains powered in low consumption mode until all the digital and/or alpha-digital data and/or binary data stored in the memory of the pen are sent back to the pieces of customer computer equipment;

the reader includes moreover a sound generator;

the programme enables to decode current barcodes among which those of EAN and UPC types;

the programme enables moreover to decode barcodes according to a corporate encoding.

The invention relates finally to a symbol reading pen as well as a method with their embodiments possibly combined according to all the technically possible combinations and corresponding to:

a symbol reading pen on a support, the pen including at one end in an optical sensor a light source generating a light beam focused on the support and an optical detector intended to receive and convert the light reflected by the support into electric signals, the pen being stand-alone and including an internal electric power supply source, an interface for two-way radiocommunication according to a preset protocol for at least one user application having data and instructions to be communicated to an external device as well as optical reading means of the optical reading head type generating electric signals relative to symbols, the user application in the form of an operating programme including a symbol recognition means and means for processing the electric signals of the optical detector, interfacing means via the radiocommunication interface ensuring at least the transmission of said symbols according to said protocol to a data-processing equipment,

the symbols are barcodes on a support,

the symbols are characters on a support,

the symbols correspond to a writing,

as an alternative to the support, the symbols are barcodes corresponding to a successive temporal chaining of dark and clear surface on a display screen,

in the case of a display screen, the light source is omitted,

a method for reading, processing, transmitting and using a symbol wherein:
one reads the symbols with a reader which is a symbol reading pen according to one or several of the previous features,
said electric signals are processed in the interface module to generate digital and/or alpha-digital data,
said digital and/or alpha-digital data are associated a reader identifier in order to generate a chain of corporate data,
one transmits in real time the chain of corporate data to at least one customer equipment including at least one customer software to carry out a command understandable by said customer equipment,

a method according to the previous feature such that when a customer equipment is not available for reception, the chain of corporate data is stored in a memory of the reader,

a method according to the previous features such that in the customer equipment one associates moreover with the chain of corporate data at least one piece of data of customer equipment type in order to build a computer address depending then on the symbol, on the reader identifier and on the data of equipment type,

a method according to the previous features such that one implements a correspondence table in order to associate a computer address with the chain of corporate data, possibly associated with at least one piece of data of customer equipment type, the correspondence table being situated in a computer server distinct from the customer equipment,

a method according to the previous features such that one implements a correspondence table in order to associate a computer address with the chain of corporate data, possibly associated with at least one piece of data of customer equipment type, the correspondence table being stored in the customer equipment,

a method according to the previous features such that one stores the correspondence table in the customer equipment by selection according to a criterion in a global correspondence table situated in a computer server distinct from the customer equipment, the criterion including at least the reader identifier,

a method according to the previous features such that one implements a transmission means by electromagnetic waves in free space between the reader and the customer equipment with a communication protocol enabling at least to determine which are the pieces of customer equipment capable of communicating and, in case when several pieces of equipment were operational, said protocol enabling to select at least one of said pieces of equipment operational,

a method according to the previous features such that one encodes according to an encoding algorithm the digital and/or alpha-digital data before associating it with the reader identifier,

a method according to the previous features such that the computer address associated with the chain of corporate data is that of a computer server relaying an information request to another computer server,

a method according to the previous features such that the symbols are barcodes on a support,

a method according to the previous features such that the symbols are characters on a support,

a method according to the previous features such that the symbols are barcodes corresponding to a successive temporal chaining of dark and clear surfaces on a display screen.

This invention will be better understood when reading non limiting embodiments in relation to:

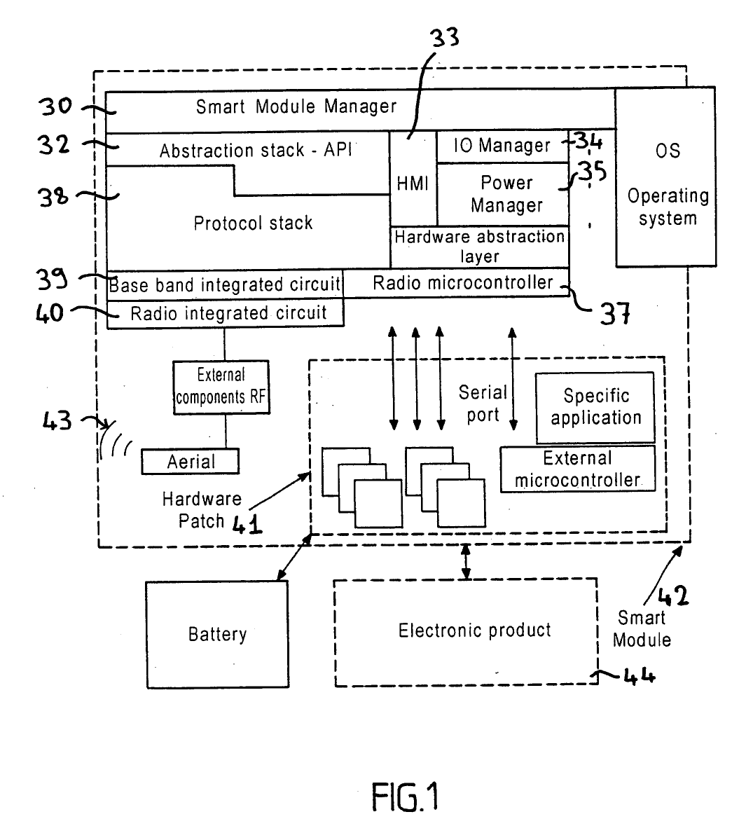

FIG. 1 representing the general architecture (hardware and software) of a Smart Module,

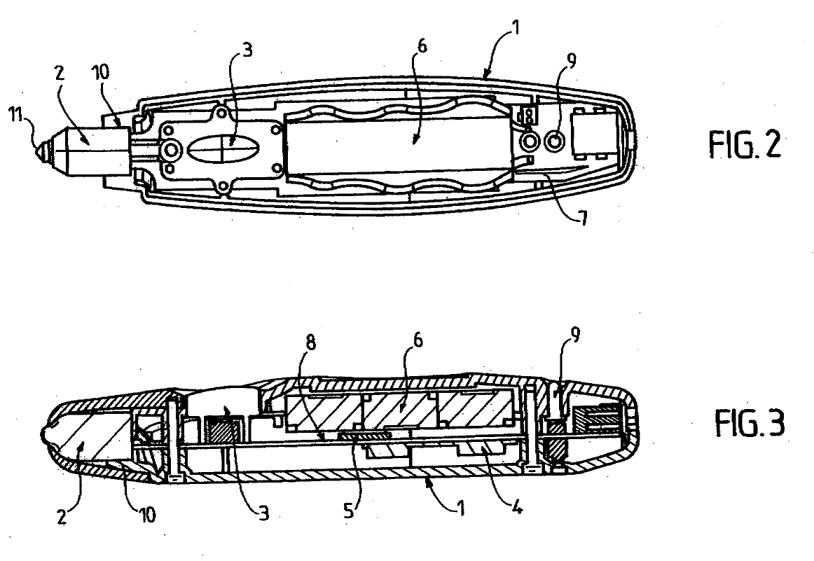

FIGS. 2 and 3 representing a reading pen according to two plans of visualisation,

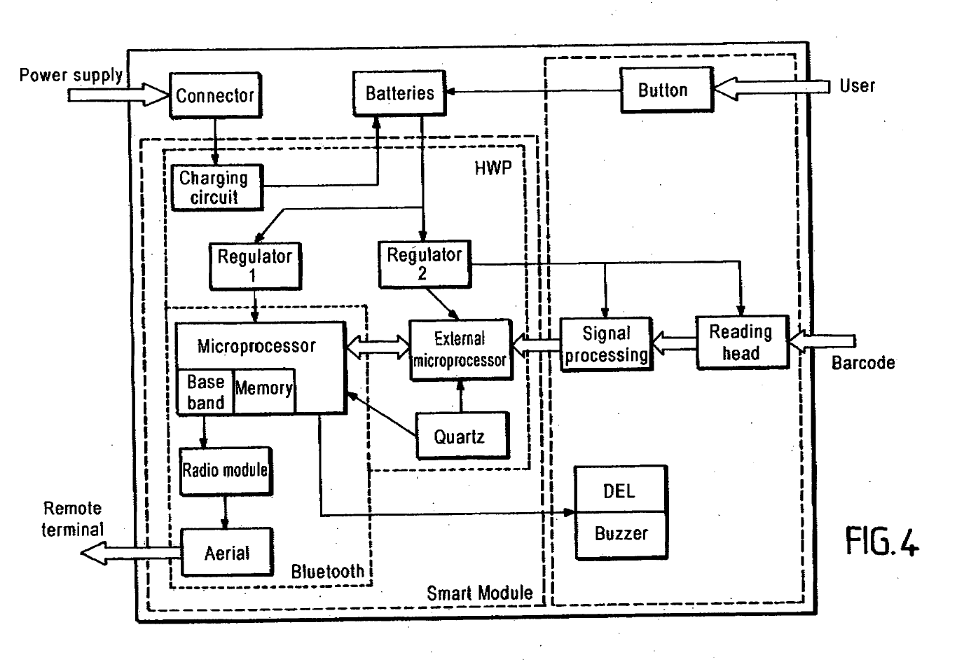

FIG. 4 representing the functional flowchart of the pen,

FIG. 5 represents the reading pen in its environment,

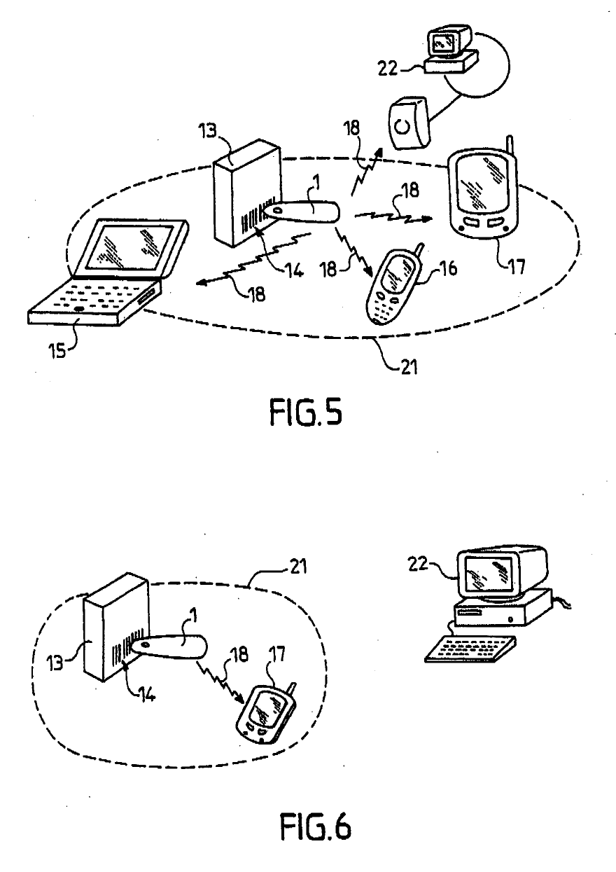

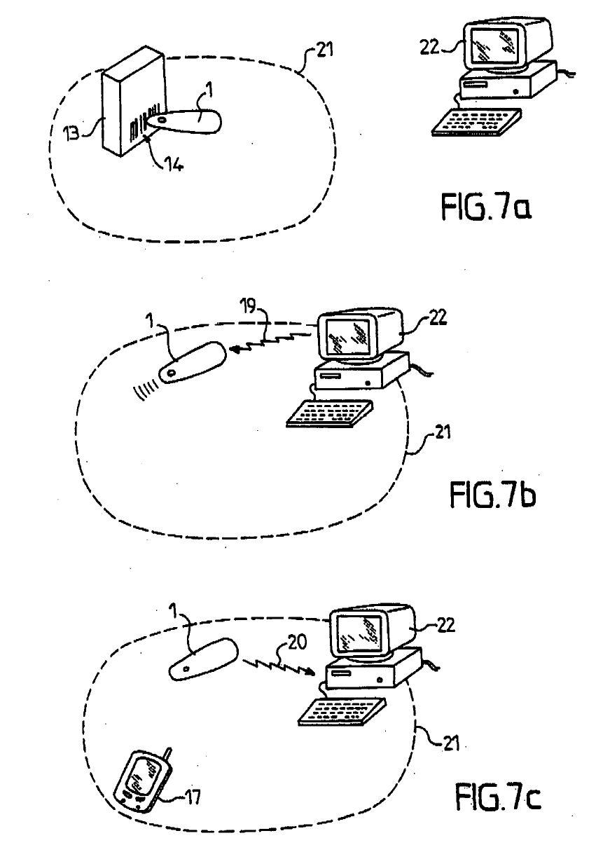

FIGS. 6 and 7a, 7b, 7c representing the operating steps of the pen,

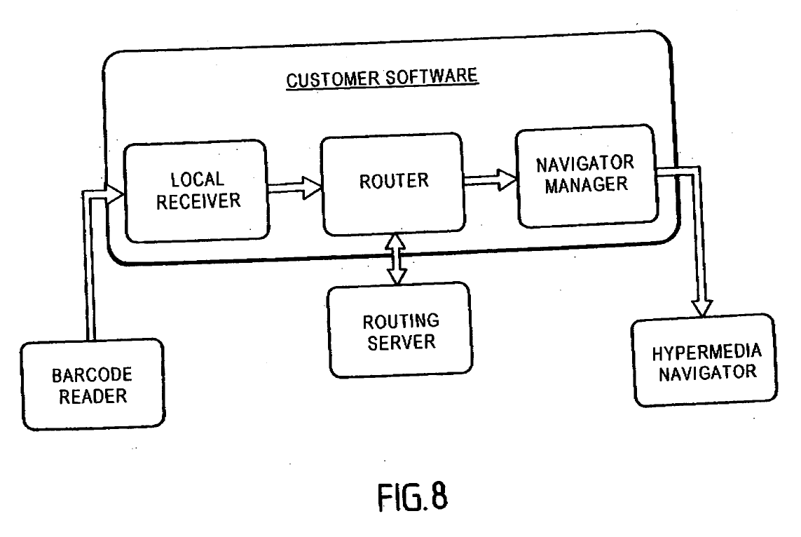

FIG. 8, representing schematically means for implementing of the method.

It should be reminded that, generally speaking, the software stack of the radiocommunication module interface includes a portion corresponding to the communication protocol (pile protocol) and a portion corresponding to the applicative abstraction stack (<<protocol abstraction API>>), the latter enabling simplified implementation of applications. The applicative abstraction stack may correspond to one or several software levels. The radiocommunication module interface, also designated <<SmartModule>> <<Baracoda®>> is a generic radio module in the form of a single hardware component which enables to carry software on-board user specific applications.

As a whole, a <<Smart Module>>, represented schematically on the FIG. 1, is composed of a radio means such as radio component, base band integrated circuit, as well as software means on-board a radio microcontroller, and as the case may be, of an aerial and/or of peripherals whereof, for example, analogue or digital inputs/outputs, a battery ensuring the autonomy of the module. The <<SmartModule>> or radiocommunication module is a generic radio module which enables to carry on-board the application software. The <<SmartModule>> is suited to all types of radio protocol, corporate or not and, for example, <<Bluetooth®>>, GPRS, CDMA2000, WCDMA, <<Home RF>>, 802.11b, <<WLAN>>, <<Wi-Fi>>, 802.11.a, <<Hyperlan>>, <<Zigbee>> or 433 MHz solutions.

The microcontroller of the interface module integrates all the software layers of the protocol in the protocol stack, the applicative abstraction stack, the profiles as well as on-board software (user application). The applicative abstraction stack which may also process instructions and corporate data, enables, for example, fine management of the power supply and low consumption modes specified in the “Bluetooth®>> standard. It enables as a whole to create an abstraction layer above the protocol stack corresponding to the protocol considered in order to provide software interface between the software specific to the protocol considered (the Bluetooth protocol stack, for example) and the user software, on-board. This interface enables, as regards the user application, to simplify the use of the protocol and to vastly facilitate the development of on-board applications using an interface radio which is complex and very specific. This enables therefore customers to accelerate the development without knowing the subtleties of the protocol used.

The peripherals associated (hardware), as well as their software management (master) enable, just as the on-board software, to facilitate the development of applications and the integration of the module in any type of electronic product.

Several peripherals are offered in a component library they may be for example voltage regulators (3.3V-5V), analogue/digital converters (ADC), digital/analogue converters (DAC), counters, comparators (at input), voltage converters, a battery charging circuit, an additional 8-bit microcontroller, basic software functions as well as inputs/outputs, for example, controlling an “LED” (light-emitting diode) or “buzzer” and reading the condition of an on/off switch or of an optical reader. These peripherals may be added or removed during the electronic integration phase of the application. In relation to the peripherals adopted or not, means for processing data and instructions of these peripherals will be or will not be inserted in the applicative abstraction stack. In a particular version, the module includes a voltage regulator enabling to supply said module from a 220V/110V power supply socket, a battery or of any other power source.

The interest of these peripherals is that they do not modify the electronic functionalities of the product wherein one integrates the <<SmartModule>>: the applications introduced do not require any modification of the electronic board of the existing product, hence a gain in cost and integration time. The selection of the different peripherals is made very quick by the use of a development kit <<SmartModule>> in the form of an electronic board whereon are welded all the peripherals which may be contemplated. In a basic version, the peripherals are not connected but it is possible to position electric wires or jumpers between the inputs/outputs of each peripheral and the microcontroller. From the position of the electric wires in the development board, one deduces therefrom the electric pattern of the module. A specific routing and cabling work of the printed circuit is then necessary. In a more evolved version, peripherals are addressable specifically through programmable logic or analogue gates and the functional configuration of the module is programmable instead of (or in addition to) the cabling phase. In particular, the microcontroller may, for example, comprise an ADC and a counter. It can be understood that the implementation of a particular peripheral relates as well to the hardware electronic circuit as to the associated software means in order to operate said peripheral and to recognise and to run corporate instructions which are specific thereto. As already seen, the software means of the module may be pre-programmed or charged at usage.

In a particular case of protocol, <<Bluetooth>>® corresponds to a standard technology of short-range communication radio between two pieces of equipment. The term customer equipment signifies computer equipment (electronic assistant, computer or mobile telephone) known by the reader. They are pieces of equipment whereof the <<Bluetooth®>> address (48 bits) is recorded in a memory of the reader. The object of the <<SmartModule>> is to facilitate the integration of the <<Bluetooth®>> technology in all types of electronic products, with a wire structure or not.

The radiocommunication module facilitates vastly the integration of said technology in electronic products since the conventional <<Bluetooth®>> devices do not integrate any on-board software and are controlled from a computer or processor external to the module (<<host>>), which requires the implementation between the device and the <<host>> of the instructions and data which are complex and specific to said technology. However, in a conventional electronic product, the processor of said product does not contain the code which enables to control the <<Bluetooth®>> device and, moreover, it is very difficult to modify the code existing in an on-board processor because of the memory size and the absence of operating system in most rustic electronic products.

The Smart Module is therefore composed of a module hardware and of a module software. FIG. 1 represents the pattern of the architecture of the Smart Module.

Hardware Architecture:

The example of <<SmartModule>> represented is composed of 2 printed circuits, welded on one another. The first printed circuit is the radio circuit properly speaking, it is composed of a aerial, of a radio, of a base band integrated circuit, of a microprocessor or microcontroller (<<radio MCU>>), of a FLASH or ROM-type programme memory and of a RAM-type memory. It is called here radio module (RM). The second printed circuit integrates at least all the peripherals necessary to the correct hardware operation of the radio module in its environment. It is called here hardware connection (Hardware Patch or HWP). Said second printed circuit may also comprise other peripherals as explained previously and which depend on the application contemplated. Still, as explained previously, one or several interfaces not used in a particular application may be present by default, if only because they are integrated by default in the electronic circuits implemented. In practice, because of the costs, several types of modules are provided including a variable number of interfaces and/or in relation to potential applications. For example, a generic module intended for the study and the development of applications may comprise a large number of interfaces as well the modules intended for the large series production will include a minimum number or simply the interfaces necessary to the application.

In other versions, the radiocommunication module is on a single printed circuit and in a high integration version, the radiocommunication module is a single integrated circuit which is hybrid or, preferably, monolithic.

Software Architecture:

The software corresponding to the stack with the protocol stack and the applicative abstraction stack and the possible applications of the user, is on-board the microcontroller(s) of the <(SmartModule)). By default and in the minimum version of the module, there is a microcontroller (microprocessor, FLASH or ROM memory, RAM memory) on the radio circuit and this microcontroller is designated the <<radio MCU>>. In more sophisticated versions of the module, it is possible to add a second microcontroller (8-bit, 16-bit, 32-bit or DSP) on the HWP, i.e. the second printed circuit in the example represented.

The interest of a second microcontroller (external MCU) lies in the possibility of carrying out specific processes which could not be contemplated on the microcontroller of the radio circuit because of real time constraints, of limitation of the calculation power of the controller of the radio circuit, of the necessity to have additional and/or specific inputs/outputs (not available on the microcontroller of the radio circuit).

The following description provides a particular example of embodiment of the radiocommunication module within the framework of the <<Bluetooth®>>, protocol.

The <<SmartModule®>> facilitates the integration of the <<Bluetooth®>> technology in all types of electronic products, with a wire structure or not and enables to accelerate the development cycle of a new product. The radio circuit is generic and there are 2 versions for the <<Bluetooth®>> protocol, a first short-range version with a maximum transmission power of 4 dBm (2.5 mW) and a second long-range version with a maximum transmission power of 20 dBm (100 mW).

The <<Radio MCU>>

The <<radio MCU>> is a microcontroller using the processor ARM7 TDMI. Other architectures 32-bit RISC can still be used. The <<radio MCU>> has a ROM or FLASH-type programme memory. This programme memory may be integrated on the chip of the processor or on an external integrated circuit and, in the latter case, the memory is in the radio module (RM). A hybrid architecture may also be implemented. The order of magnitude of the size of this ROM/FLASH memory is 1 Mbit to 32 Mbit, where this parameter may be led to change relative to technologic evolutions and/or memory requirements of the application. A RAM memory is also on-board the radio module (RM). It has a size of the order of 16 KBytes to 128 Kbytes, parameter depending on the technologic evolutions and/or memory requirements of the application. A memory internal to the microcontroller and an external memory may be associated in the radio module (RM) in case when the memory requirements are significant, as well as for the ROM/FLASH as for the RAM. Counters (<<timer>>) are also integrated in the <<radio MCU>>.

The Protocal Stack

The portion of the software stack corresponding to the management of the protocol Bluetooth, stack protocol, is in this example, the <<Bluetooth® protocol Stack>>, includes the lower layers of the software (beneath the interface HCl), the higher layers (L2CAP, SDP, RFCOMM) as well as the <<profiles>>, above the higher layers of Bluetooth. The <<Bluetooth®>> profiles are just beneath the applicative translation unit (applicative abstraction layer), itself beneath the possible applications of the user.

The Applicative Abstraction Stack

This applicative abstraction stack (<<protocol abstraction-API>>) is arranged functionally above the layers or levels of the stack protocol, enabling a user application to use services of all the layers of the <<Bluetooth®>> protocol and to benefit from the wealth of this standard and, as already seen, possible additional local functionalities (local interface management, specific instructions . . . ).

This portion of the software stack is partially common to all the <<Smart Modules>> used in data acquisition tools (barcode reading, magnetic badge or contact-less reading, chip board reading, mouse, keyboard, temperature sensor, pressure sensor, movement sensor, writing recognition, CCD or CMOS camera, etc. . . . ). For other types of usage, there is provided another type of applicative abstraction stack. In all cases, said stack enables to develop applications as simply as possible and independently from the instructions and formats of the communication protocol considered. This applicative abstraction stack enables to access the radio interface without knowing the <<Bluetooth®>> protocol.

The user has three main commands:

a data sending command which specifies the size of the data to be sent (2 bytes), the <<Bluetooth®>> address (48-bit MAC address) of the assignee (6 bytes), the profile used (1 byte), a service quality parameter (1 byte) and the data (<<payload>>).

a request command (<<inquiry>>) enabling the application <<Smart Module Manager>> situated above the applicative abstraction stack to find all the <<Bluetooth®>> products accessible in the vicinity and to recognise services that they offer.

listening to the <<Smart Module>> with a parameter (1 byte) characterising the listening mode.

These request commands (<<inquiry>>) and these listening mode activation commands are close to those offered by the GAP (<<General Access Profile>>). Conversely, the first primitive send command is a very abstraction which masks the complexity of the <<Bluetooth®>> protocol and which enables a gain in development time. We shall now detail the different parameters used in the send command:

BDADR (<<Bluetooth®>> address of the assignee of the shipment): this address is provided by the <<Smart Module Manager>>. Different addresses are stored in the non-volatile memory of the <<Smart Module>>, they come either from a configuration phase, or a request phase (<<inquiry>>). The origin of the <<Bluetooth®>> addresses is not managed by the applicative abstraction stack, but at still higher a level by the <<Smart Module Manager>>.

the profile: one of the specificities of the <<Smart Module>> is to be able to manage a multi-terminal and multi-profile intelligent operation. This aspect will be detailed in the particular case of the use of the <<Smart Module>> inside the barcode reading pen.

the service quality: this parameter defines whether an authentication is required, whether data should be encrypted, what usage type of the low consumption modes should be employed (arbitration level between consumption and delay for sending data).

<<Smart Module Manager>>

It is a piece of software specific to the product wherein the Smart radiocommunication module is integrated. This layer is truly the control layer of the <<Smart Module>>. It is a high level software layer which enables to do away with the complexity of the radio protocol but also with the interconnection difficulties between the <<Smart Module>> and the product wherein it is integrated.

A portion of the <<Smart Module Manager>> manages the sending of data to one or several terminals twinned with the module in the configuration phase. It therefore enables to manage a multi-terminal connection and to adapt the connection mode and the type of <<profile>> used in relation to the terminal.

During the configuration phase, several Bluetooth addresses of twinned terminals are recorded in a memory non-volatile of the Smart Module.

This layer is a corporate sub-layer developed by Baracoda. It may be used in Smart Modules integrated in all types of data acquisition tools, such as barcode readers, among others.

The <<Smart Module Manager>> uses the services of the software HMI, <<Power Manager>>, <<IO Manager>> (inputs/outputs management) or any other type of specific application (decoding barcodes, encryption, form recognition algorithm, encoding/decoding of the video, voice, and image). This specific application may also be a protocol stack (TCP/IP for example). These vertical applications may operate on the radio microcontroller or on a specific external microcontroller if necessary.

The <<Smart Module Manager>> uses a number of software packages which are now described:

MMI (<<Man Machine Interface>>):

This software is specific to the environment wherein the <<Smart Module>> is used. It enables to manage by a software the modification of the man/machine interface induced by the addition of a radio and of a battery. The user must notably be informed of any successful shipment or not of data and/or when the battery is charged insufficiently and/or when it is in charging mode. The man/machine interface is managed at the MMI layer of the <<Smart Module>>. Hardware implementation of this software may be carried out either by using conventional peripherals such as LED, <<Buzzer>>, LCD screen or others, or, possibly associated, with new peripherals integrated on the HWP (battery charging circuit) to that end or at the terminal(s) with which the product is set up. For example, the battery level of the product wherein the <<Smart Module>> is integrated may appear at the terminal and not on the product.

Power Manager (<<Power Manager>>):

This software enables to use the Smart Module as power supply controller. More precisely, this application software enables to control several power supply zones within the same product. The purpose is to control by a software several regulators or transistors which enable to supply or not certain electric zones of the <<Smart Module>> properly speaking and also of the product wherein it is implemented. These regulators and transistors are positioned on the hardware patch. It should be noted that the battery charge management is not taken into account at the <<Power Manager>> software, but at the HWP (battery charge circuit).

Management of Inputs and Outputs (<<IO Manager>>):

It is a layer which manages all the inputs/outputs between the product and the <<Smart module>>. They are for example of the serial link type (synchronous or asynchronous) or parallel, analogue or digital.

On FIGS. 2 and 3, a pen 1 is seen in transparency. Inside a box 10 of plastic material, an optical sensor 2 is arranged towards an end in relation to an optical channel 11 of hard material ahead of said pen 1. A communication module of Smart Module type is implemented in the form of a printed circuit 8 including an on/off switching means 3, push-button, a radio-electric component 4 according to the <<Bluetooth®>> protocol, a microcontroller 5 including read-only memory and random-access memory, whereas the memory may be one of the following types: ROM, EPROM, EEPROM, RAM, Flash, SRAM and an electric power supply source 6 in the form of two single-use batteries or of rechargeable batteries. The optical sensor 2, the printed circuit 8, the power supply 6 are held in place by attachment means of the box 10. The pen as claimed is an application of the interface module claimed. The Smart Module used, integrates a two-way radio component and a base band integrated circuit, according to the “Bluetooth®>> standard, as well as a microcontroller enabling to carry on-board, in whole or in part, the <<Bluetooth®>> protocol stack as well as dedicated software applications. An additional microcontroller may be used for the listening phase, corresponding to the measurement of the successive lengths of a barcode. The decoding is performed either on the external microcontroller or on the microcontroller on-board the <<Bluetooth®>> chip.

On FIG. 4, the previous pen is seen according to a plane perpendicular to the previous one enabling to observe on the printed circuit 8 a light-emitting diode (LED) 9 and an aerial 7 for the radio electric module 4. The aerial 7 is here an aerial of <<wire structure>> type printed on the printed circuit, but it might also be an aerial of <<patch>> type or any other type of radiating element placed inside the pen. The two-colour LED 9 enables to inform the user on the operating condition of the pen. This LED 9 may be replaced with any other type of alarm (sound generator, buzzer for example).

The optical sensor arranged at one end of the reader implements reflection optics with a light-emitting diode, for example of 700 nm wavelength, and a photodiode. An aspheric forked lens or, in another embodiment not represented, a system of optical fibres, is arranged at the front of the light-emitting diode and of the photodiode in order to obtain a single focus point at the front of the pen. The output signal of the optical sensor is a current generated in the photodiode and which is amplified by a transistor or an operational amplifier and which is converted into a binary voltage which may be processed by the microcontroller 5. A black surface absorbs the light emitted by the sensor and, in such a case, the output current is weak, the output is at a logic level 1. Conversely, outside a black surface, the light is reflected and the output voltage is at a logic level 0.

The reader includes a box 10 and the optical sensor is held in the box at constant distance from the end of the pen, an optical channel 11 being realised between said end and the sensor. Preferably, the optical channel is a light guide (optical fibre for example) or a lens (spherical tip) made of <<hard>> material.

The pen type reader of the invention is simple to make and includes preferably a box made of moulded plastic material and implements a reduced number of parts. The electronic circuit of the reader includes a programme in a read-only memory intended for decoding barcodes of one of the following types: EAN, UPC, codes 128, code 39 and possibly specific barcodes. Preferably, the specific barcodes comprise error correction means. Preferably, the specific barcodes are encoded in order to comprise redundancies enabling, during decoding, to correct errors made when reading said barcode. These corporate barcodes are encoded according to the principle of error correction codes used conventionally in the field of telecommunications.

Contrary to the state of the art, the pen claimed may read new types of barcodes on display screens, for example of television sets, computers or electronic assistants as well as screens of mobile telephones or any other type of screen using the plasma, TFT, liquid crystal (LCD) technology or by scanning (VGA, XVGA . . . ). The barcodes used in such a case are very different from those of the state of the art: these are not codes having any <<spatial extension>> but rather a <<time extension>>. More precisely, the barcodes claimed in the invention correspond to a succession of dark and clear surfaces on the display screen. As a traditional barcode, the information is encoded in the successive durations of the bars and spaces of the code. The user sees this code as a quick flashing of the screen. As this code is decoded by the pen claimed, the user holds said pen in contact with the screen; whereas no displacement is performed on the screen. This characteristic of the pen is a feature of the decoder (software module on-board the pen) and of the analogue circuit carrying out the conversion of the analogue signal from the photodiode, into a digital signal. The main difficulty of this decoding type lies on the one hand in the low contrast between a <<white>> screen and a <<black>> screen. On the other hand, in scanning-type systems, a refreshing frequency is used and complicates the decoding very much. This characteristic being particular mainly to the decoding software, it is independent of the reading technology used (CCD, contact reading, CMOS sensor).

This example of reader in the form of a simplified reading pen which is stand-alone with low cost enables implementation of the method in everyday life and more especially in relation to computer means of the hypertext type (hypermedia) on micro-computer, personal assistant, mobile telephone, access point or others. However, any type of reader including the functionalities specified may be implemented with the method of the invention.

The element common to the various reading technologies implemented is the interface module or Smart Module.

On FIG. 4 is represented a block diagram of the pen. Said diagram enables among other things to integrate the on-board software and enables therefore to use the component Bluetooth, on the one hand to send and receive data by radio and on the other hand, to perform the decoding of the barcode, the management of the man/machine interface as well as the management of the power consumption and of the battery. This enables to reduce the complexity (size of memory, calculation power) of the external microcontroller and hence to reduce the hardware cost of the product. The original architecture (software and hardware) of the Smart Module, claimed in the invention, enables therefore to reduce very significantly the cost of a wireless reading pen and may therefore accelerate the implementation of the method in everyday life and more particularly in relation to computer means of the hypertext type (hypermedia)

In a particular embodiment of the reader, for example the pen described, the push-button is arranged so that the user positions necessarily the reader in a given orientation with respect to the barcode. The push-button is thus arranged so that the pickup element of the user holds the reader in a given position so that he may depress the button and launch the reading cycle. This given orientation is such that the reader is substantially vertical, i.e. substantially perpendicular with respect to the support of the barcode, when reading. In case when the user should scan the barcode manually, the push-button is also arranged to facilitate said scanning and, for example, so that the pickup element of the user works according to scanning habits used when writing manually.

On FIG. 5, one has represented a pen 1 when reading a barcode 14 on an object 13. In the close environment which may be reached by radio-electric waves 18 of the module 4 several pieces of computer equipment are arranged which may communicate by electromagnetic waves according to the <<Bluetooth>>® protocol with said pen 1. These pieces of equipment are a micro-computer 15, a mobile telephone 16, with hypertext functionalities, a personal assistant 17 and one or several access points to a local network.

Initialisation and Configuration Phase

A first initialisation phase is provided for the configuration of the pen. The purpose of this phase is to specify which peripherals are <<twinned>> with the reader. This initialisation method is managed at the processor on-board the Smart Module, at the software Smart Module Manager. It comprises 4 steps:
1—Downloading the customer software on one of the user terminals (micro-computer for example). This software is described schematically on FIG. 9.
2—The user must then select the set of terminals with which he wants to <<twin>> the pen. Two means are possible to fill in this list: or, the user performs, from the terminal, an <<inquiry>> and selects the terminals found by the inquiry. This requires that the user configures all the terminals in listening mode (<<discoverable>>). Or the user fills <<in long hand>> the list of Bluetooth addresses (48-bit MAC address). Once the list of the terminals is formed, the user must then fill in a field containing the identifier number of the pen (48-bit address of the pen or any other identifier type of the pen). The customer software then prompts the user to switch the pen into listening mode.
3—Several means are offered to the user to switch the pen into listening mode (<<discoverable mode>>). The first corresponds to reading a specific barcode (corporate code) and the second method corresponds to the position of the pen in contact with a <<white>> paper for a duration of the order of 1 to 5s approximately. These listening parameters of the pen may evolve and this description is not exhaustive. In parallel, the customer software attempts a connection towards the pen and sends the information specific to the configuration: list of addresses of the peripherals or twinned terminals, the description of the <<profile>> to be used for each terminal, as well as an order of priority associated with each piece of equipment. The NULL or BATCH terminal may be part of the list of the twinned terminals. The purpose is to configure the reader in asynchronous mode: instead of trying to send, over radio, a decoded barcode towards a remote terminal, the pen stores said barcode in its non-volatile memory.
4—The configuration data is then stored in the non-volatile memory of the pen and might be modified at each instant by performing again a configuration phase. Upon completed initialisation of the reader, the user is informed of the success of the initialisation phase via the man/machine interface of the pen and/or of the user terminal.

Once this initialisation phase has been conducted, the pen may be used as follows:

On FIG. 6, only the telephone 17 is functional. The link is then established between the equipment and the pen, the data read by the pen is read in the form of sets of digital or alpha-digital or binary data is transmitted by electromagnetic waves 20 towards the equipment 16 as represented on FIG. 3c. The transmission of data is performed in real time, the data being transmitted as it is read and decoded or in quasi-real time, the handshake with the equipment or the pieces of equipment of the environment taking place before the transmission, the chains of data being stored temporally in the pen 1 as said link is being established. Between reading 2 consecutive barcodes, the connection is held to maintain reduced consumption.

Management of Low Consumption Modes

The power consumption is an essential element in the operation of the pen. The <<Bluetooth®>> protocol has a great intrinsic advantage in terms of consumption with respect to other radio standards like 802.11b. Nevertheless, the <<Bluetooth®>> protocol needs to be used in all its complexity and notably in terms of management of low consumption modes. The <<Bluetooth®>> abstraction stack integrates this efficient management of the <<Bluetooth®>> connection modes.

When reading the barcode for the first time, the connection is created. When the barcode is sent, the radio connection switches into <<sniff>> mode with a short <<Sniff>> interval. This enables to keep a limited latency time. After a certain time period (T1), the <<sniff>> period is increased in order to reduce the consumption still further. The shortcoming in such a case is an increase in the lead time for sending a barcode. It is nevertheless not a problem since, in such a case, the duration between 2 successive readings is long and the sending lead time is not fundamental. After a certain time (T2), the reader switches into <<parked mode>> after exchanging the master/slave roles. After a time T3, the radio connection is cut off and the power supply of the Smart Module is turned off.

The durations T1, T2, T3 are variable parameters which are adapted to the usage mode of the user and provide statistics of durations between successive readings. For a given user reading barcodes at an average high rate, the values of T1, T2 and T3 will be selected as shorter.

Multi-Terminal Connection Management

FIG. 5 represents a pen in its environment. The pen may be set up with different and quite diverse pieces of equipment. It is one of the significant elements of the “Bluetooth®” standard: interoperability and multi-terminal connectivity. Nevertheless, even if these services are provided by the “Bluetooth®” standard, it is still necessary to manage this connectivity in an intelligent way taking into account the fact that the man/machine interface at the pen is very reduced and that it does not enable therefore to select towards which pieces of equipment the pen must be connected. This intelligent management is a feature of the pen and is integrated in the applicative layer of the Smart Module.

During the configuration, the devices with which the pen may be connected are recorded in the non-volatile memory of the pen.

If the pen has been configured in asynchronous mode (by using only the NULL terminal in the configuration phase), each decoded barcode will be stored automatically in the non-volatile memory of the pen (FIG. 7a). In order to access at a later stage the data recorded in the pen, the user must proceed to an upload or charging phase of the data. This phase is performed by switching the pen into listening mode (by reading a corporate code for example) (FIG. 7b) while actuating the charging function on the customer software (micro-computer for example). All the barcodes in memory are then transferred by radio waves towards the user terminal (FIG. 7c).

In the case of a real-time mode configuration (FIG. 6), i.e. the pen has been configured with at least one non-NULL (or BATCH) user equipment, the pen tries to connect with different pieces of equipment in memory in order of priority or by using the equipment twinned last. This handshake takes place only at the beginning of a reading phase. A reading phase being characterised in that between 2 successive readings, the duration is shorter than T3 (duration of inactivity before total extinction of the power supply). Throughout the reading phase, the connection is held in low consumption modes as described in the portion called <<management of low consumption modes>>. If none of the pieces of equipment twinned reacts to the handshake from the pen, said pen is configured automatically (after one or several fruitless attempts) in asynchronous mode during the same reading phase.

The heterogeneity of the twinned terminals with a pen is very important. The handshake modes, specified in the <<profiles>> of the <<Bluetooth®>> standard are very different of from one type of terminal to another. The on-board software in the Smart Module of the pen is capable of managing several <<profiles>>. More precisely, the applicative abstraction layer selects automatically the appropriate handshake mode in relation to the piece of equipment with which the pen wants to connect.

For example, in the case of an access point, the <<profile>> which is adequate is the <<Lan Access Point Profile>>, for a computer or digital assistant, it is the <<Serial Port Profile>> or <<HID profile>> and for a telephone it will be either the <<DialUp Networking Profile>>, by sending AT commands towards the telephone. In such a case, the customer software is reduced to NULL on the terminal: the hypermedia navigator of the telephone being remote-controlled by the pen via AT commands. Other solutions may be implemented, notably, it is possible to download a customer software on the SIM card of the mobile or in the processor memory of the telephone.

Battery Management

The battery of the pen is rechargeable via an electronic circuit, integrated in the Smart Module. Several voltage regulators, voltage controlled, are used on the Smart Module to control by a software, the power supply of different zones independent of the pen. For example, when the user releases the action button, the zone corresponding to the reading head is not power supplied. Conversely, the power supply of the radio module remains as long as the on-board software requests so. This enables finer management of the consumption of the pen while separating correctly by functionalities the different electronic circuits forming the pen.

Man/Machine Interface Management

This interface is managed by the software in the Smart Module of the pen. On the pen there are light-emitting diodes or a sound generator. This interface enables to signal the user a good reading or a bad reading, a successful radio send or not. It also enables to inform the user when the battery level is too low. A portion of this man/machine interface can be delocalised on the terminal when said terminal is provided with a richer interface (micro-computer or mobile telephone for example)

In its application, the invention is structured around four components:

the barcode reader,

the customer equipment,

the routing server,

the document server, possibly reached by a relay server (proxy).

Anyone who wishes to access the information and services associated with a resource uses the barcode reader to scan the barcode referring to this resource. The reader then decodes the barcode to generate a resource identifier. Said identifier is sent with the own identifier of the reader towards the customer equipment, through a local connection.

The customer equipment processes the identifiers received to determine the address of an appropriate document server. This server has the hypermedia documents exhibiting the information and services relative to the resource designated with the reader. The customer equipment may, to facilitate its address research, obtain additional information from the routing server.

The identifiers from the reader are then relayed through a remote connection towards the document server, whereof the address has just been determined by the customer equipment. Additional information whereof the user has authorised the broadcast may at this stage be transmitted over by the same channel.

Possibly, the remote connection towards the document server goes through a relay server or proxy, which is capable of storing the request and/or of processing it for statistical purposes or others, before transmitting it integrally to the document server.

Finally, the document server processes the data which has been transmitted thereto in order to send back to the customer equipment the hypermedia document which will enable the user to access the information and services requested.

All these steps take advantage of the latest technological breakthroughs in the field of telecommunications to offer real-time or quasi real-time service: there are only a few seconds between the scanning of the barcode and the presentation of the associated hypermedia document.

The barcode reader is a piece of hardware equipment capable of decoding a barcode into electric signals then into digital and/or alpha-digital data. Such data forms an identifier of the resource referred to by the barcode. This resource identifier and another identifier personal to the reader are both transmitted towards the customer equipment via a local connection.

The reader is intended for general public and consequently should be cheap enough. It may conversely be of modest quality in comparison with industrial readers since its use is vastly less intensive.

it can be broken down into four main portions:
an optical transceiver,
a power supply,
a local transmitter,
a box.

The local connection is a short-range communication link between two pieces of equipment. The distance between the pieces of equipment does not exceed a few ten metres.

Comprised as an electronic device, the local connection locale designates a short-range transceiver controlled via a communication protocol.

The customer equipment is the central element of the system. The customer equipment is a piece of user equipment implementing the customer software. The user equipment is a piece of hardware equipment possessed by the user.

It may have various characteristics, mobile or not, providing the following elements are available:
a local connection,
a remote connection,
an operating system with a documented programming interface,
a hypermedia navigator.

Concretely, a piece of mobile equipment may be a computer or a digital assistant connected to the Internet, a WAP mobile telephone offering programming possibilities, a GPRS, UMTS terminal or any other piece of equipment meeting the conditions detailed previously.

The remote connection is world-wide communication link between two pieces of equipment. It almost always implements global networks, whereof the Internet is the best representative. In this context, it may be contemplated to have all the requests transit via a set relay server (proxy), so that said relay updates the global information regarding the set of requests. In all cases, the requests are at least transmitted integrally. Comprised as an electronic device, the remote connection designates a network transceiver, possibly controlled via communication protocols.

The customer software is a piece of software running on any type of user equipment to fulfil the following functions:
receive the identifiers transmitted by the barcode reader via the local connection,
provide the user with the hypermedia document for accessing the information and services relative to the resource designated by the reader.

This piece of software is called customer software since it behaves as a customer for the routing server on the one hand and for the document server whereof it must determine the address on the other hand.

It is realised as an application programme, for example using an object-oriented programming language such as C++ or Java. It controls the user equipment via the programming interface specific to such equipment.

The installation of this piece of software on a piece of user equipment may require a programme to be downloaded, the insertion of an electronic board whereon it is implanted (chop card for mobile telephone, extension card for portable computer or digital assistant) or any other electronic or computerised method.

The customer software may be broken down into three modules:
a local receiver,
a router,
a navigator manager.

The local receiver is a programme whereof the role consists in listening further for the local connection. It reacts to any message from the barcode reader while activating the router and while transmitting to said reader the identifiers received from the reader.

This programme is running as long as the system is actuated. Conversely, when no message from the reader is being processed, it is the single portion of the customer software in operation, which reduces the consumption of the resources of the user equipment.

The router is a programme receiving from the local receiver the resource identifier and the reader identifier. Its role consists in applying to these identifiers the address resolution algorithm to attempt to determine the WEB address of a document server appropriate to the resource referred.

If such an address is obtained, the router adds according to a set syntax both previous identifiers, as well as certain information which the user may have chosen to provide on its equipment (for example certain preferences or restrictions). The address thus completed locates without any ambiguity a hypermedia document exhibiting information and services relative to the resource identified via the reader. The router then actuates the navigator manager and transmits to said manager the address of the document.

The address resolution algorithm is applied to the resource and reader identifiers. This algorithm processes first of all the reader identifier. If the identifier is known, i.e. if it listed on a routing table (correspondence) stored on the user equipment and managed by the router, then the programme extracts from the same table the routing information regarding the reader.

The routing table may be realised with diverse data structures; it forms a very simplified system for database management.

The routing information may contain:

a history of the previous requests with their result, whereof one will be able to extract the address of a document server;

a single address of document server, for example in case when the reader is exclusively affiliated to such server or a relay server address, through which all the requests pertaining to a document server should transit;

any other information peculiar to the reader and useful to the address resolution.

In a second stage, the address resolution algorithm processes the resource identifier and the routing information extracted during the first step. In some cases, this data is sufficient to generate the address of the document server associated with the resource referred. For example, it may be agreed that an identifier exhibiting certain similarities with another identifier processed during a previous request must be associated with the address which resulted from this request.

If is not possible to conclude with this single data, the router transmits to the routing server the reader identifier and the resource reader, via the remote connection. This server returns to the router the address of the document server which it is waiting for, as well as possibly the address of a relay server (proxy) associated, and these addresses are stored in the routing table.

The address resolution algorithm has therefore enabled to determine the address of the document server with at most a remote access to the routing server. It should be noted however that it may be necessary to refresh periodically the routing information, via additional requests transmitted to the routing server during possible remote access.

In case when the reader identifier is not known from the router, the behaviour of the latter depends on the operating mode wherein the user has placed its customer equipment. In current mode, the resolution procedure is aborted and the message from the reader is therefore ignored. This normal situation may for example crop up if a message radio-transmitted by a user's reader is received by the customer equipment of another user, who is not interested at all in his neighbour's intentions.

If, conversely, the user has placed its customer equipment in receiving mode of a new barcode reader, then the new reader identifier is transmitted towards the routing server via the remote connection, so that this server sends back to the router the routing information peculiar to the new reader. The receiving mode enables therefore to record a new reader. Such information is placed in a new entry to the routing table, and the processing of the request by the customer software is completed.

The navigator manager is a programme whereof the role consists in causing the hypermedia navigator available on the user equipment to provide the hypermedia document located by the address received from the router.

The user is then free to navigate at will from the document which is presented to him.

The navigator manager only controls the display of a document to the usual navigator of the user, who remains perfectly free to set it up at his discretion.

To illustrate the mechanism implemented, one may consider the example of a WEB navigator to whom the navigator manager will order the creation of a new window to display an HTML document. The address of this document is provided to the navigator in the form of a URL complying with the HTTP protocol.

Another example consists in reproducing on a mobile telephone connected to the Internet a sound document, located by an address complying with the WAP protocol.

The routing server is the auxiliary information source of the <<Baracoda®>> system (denomination adopted for the set of components, methods and services linked with the invention).

The routing server is a piece of software running on one or several computers fitted with a remote connection to fulfil the following functions:
manage and update the routing information peculiar to each barcode reader;
manage and update the information enabling to associate the WEB address of a relay server with the WEB address of a document server;
manage and update the information enabling to associate the WEB address of a document server to a resource identifier accompanied by a reader identifier;
manage and update the code of the different programmes forming the customer software;
listen further to the remote connection in order to react to the requests of a customer equipment by transmitting to said customer the information that he requests.

It behaves therefore as a server for each piece of customer equipment, whereas the number of customers may be quite high. It responds to the different requests of the router, but also to installation requests from a piece of user equipment that has not been fitted with the customer software.

The software routing server may be a single software running on a single computer, or be distributed on several computers. The network organisation of these machines may itself implement diverse architectures:

a hierarchical architecture, according to which the machines situated at the lowest nodes hold local information and refer to higher rank machines to obtain more general information;

a neighbouring architecture, each machine being at the same rank as its neighbours and working in co-operation with the latter to access largely distributed information;

any other architecture deemed efficient to share the processing load and capable of improving the response time to requests.

The communication between the routing server and a piece of customer equipment may employ a corporate protocol specifically designed to that end or a public protocol (HTTP or WAP for example). Different protocols may be selected according to the nature of the customer equipment (computer, digital assistant, mobile telephone, etc.).

The document server is the last element of the ‘<Baracoda®>> system.

The document server is a piece of software running on one or several computers fitted with a remote connection to fulfil the following functions:
manage and update a large number of hypermedia documents showing the information and services relative to certain resources;
listen further to the remote connection in order to react to the requests of a hypermedia navigator by transmitting to said navigator the document that he requests.

The routing tables stored on the customer equipment or on the routing server comprise not only the addresses of document servers but also the addresses of relay servers associated with the document servers. The software component called “router” of the “customer software” is therefore capable of providing the component called “navigator manager” with an address based on that of the relay server, so that the latter filters all the requests send to a given document server.

The relay server only re-transmits the request to the document server which is the final assignee thereof. But it may in passing memorise that a request has been made and perform statistical processing of all the requests thus relayed. This additional service offered to certain document servers may constitute an added value for anyone whose wishes to know the look-up frequency based upon the barcodes, the total volume of requests, their time distribution, etc.

The document server is the property of a third party wishing to provide the documents relative to certain resources. It is implemented and managed to the discretion of the owner. For example it may be the server of an industrial company publishing its catalogue of products on the Internet. However, it must in order to be integrated into the <<Baracoda®>> system, be capable of interpreting the address transmitted by the navigator manager via the navigator.

To guarantee such compatibility at the lowest possible cost, the address considered is in most cases in compliance with a public protocol. It may be for example URL, HTTP or WAP. In such a case, the upgrade of an existing WEB server only requires minor adaptation, for example the design of a single page of dynamic redirection.

The application of the radiocommunication module is not limited to the method for reading barcodes and it is possible to implement the module in other applications.

For example, the <<Bluetooth®>>—GPRS router is an electronic apparatus composed of a <<SmartModule>> and of a modem GSM, GPRS, EDGE or UMTS. Said apparatus carries out the conversion of protocol between the <<Bluetooth®>> communication protocol and the GPRS, EDGE or UMTS protocol. It enables for example <<Bluetooth®>> products to access a remote network (Internet network for example). The applications of such apparatus are numerous in the field of house computerised appliances and the field of Internet access (ISP) for a residential user or a small company.

The apparatus consists of a radiocommunication module and of a GSM/GPRS/EDGE/UMTS radio with management of the physical layer of the GSM/GPRS/EDGE/UMTS protocol and of the protocol stack considered as well as of a specific software managing the quality of service and the sharing of the pass-band between the different users. Up to 7 products fitted with the apparatus may use the services of the GPRS/UMTS simultaneously, via the same <<Bluetooth®>>—GPRS router. More than 7 pieces of equipment (up to 255) may access these services via the same router, but not simultaneously. These pieces of equipment may use a token protocol (developed on the processor of the router) in order to send or receive data regularly using the GPRS/UMTS connection.

Thanks to the apparatus which integrates the necessary hardware and software, the user does not need to manage the complexity of the routing software due to the necessity of sharing the pass-band in the ascending direction (from the <<Bluetooth®>>—GPRS access point towards the GPRS base station).

The <<Bluetooth®>>—GPRS router is also used as a <<Hub>> within the framework of the construction of a local <<Bluetooth®>> network. One may also implement such router in house computerised appliances. Refrigerators, alarms, radiators, lighting units, on/off switches, thermometers and others sensors (water, gas, electricity meters), television set, VCRs may be connected to a remote network via a <<Bluetooth®>>—GPRS access point which is this <<Bluetooth®>>—GPRS router. In such an application of the router it is for example possible to activate the heating system of one's country house via its mobile telephone, remotely. The router may also be applied for accessing Internet at home with PCs or PDAs (portable electronic assistant) or inside a car.

1-31. (canceled)

32. Interface module (42) for two-way radiocommunication according to the <<Bluetooth®>> protocol for at least one user application having data and instructions to be communicated to an external device, the module including at least one radio electronic circuit (39, 40) for sending and receiving digital signals (43) and at least one programmable electronic circuit with a radio microcontroller (37) for managing the radio electronic circuit (39, 40), wherein the radio microcontroller (37) includes hardware means cooperating with software packages in the form of a software stack formed of a first section so-called protocol stack (38) topped with a second section so-called applicative abstraction stack (32), the software stack enabling adaptation according to the protocol between, on the one hand, the digital signals (43) and, on the other hand, the data and instructions of the user application, the applicative abstraction stack (32) enabling at least the translation of data and instructions of the user application into a corporate format in data and instructions according to the protocol for processing in the stack in order to enable the development of the application independently from the instructions and formats of the radiocommunication protocol, the module being a single hardware component also storing the user application in the form of a programme and ensuring its realization in the radio microcontroller (37), the software operation of the module being divided into tasks performed according to priorities, the tasks associated with the management of the radio circuit having higher priority than the execution tasks of the user application.

33. A module according to claim 32, wherein the applicative abstraction stack temporally manages the <<Bluetooth®>> connection mode, the interval of the running of the radio connection being modified according to the use of the module and in the course of time in order to manage the consumption of said module.

34. A module according to claim 33, wherein it includes, on the one hand, a radio printed circuit including an aerial, the radio electronic circuit for sending and receiving in the form of a radio and of a base band integrated circuit and the programmable electronic management circuit in the form of a microcontroller with storage means and, on the other hand, a printed circuit (41) interconnected with the radio printed circuit including at least one peripheral at least selected amongst:
a digital input with possibly a comparator for level or transition detection,
an analogue input with analogue-digital converter with possibly an analogue amplifier with programmable gain or not,
a digital output,
an analogue output with digital-analogue converter,
a voltage controllable regulator or converter,
an up/down counter,
a real time clock,
a charger circuit for battery,
a logic circuit,
a memory,
a specialized programmable logic circuit notably selected amongst a microprocessor, a microcontroller, a digital signal processor or a dedicated circuit, a portion at least of the user application in the form of a programme being then stored in said specialized programmable logic circuit and said specialized programmable logic circuit ensuring then its realization,
the applicative abstraction stack (32) may moreover comprise corporate software means for processing instructions for retrieving data from the peripheral and/or sending data to the peripheral.

35. A module according to claim 34, wherein it includes a reprogrammable memory as well as means enabling reprogrammation of said memory on the basis of data received by radiocommunication.

36. A module according to claim 35, wherein the user application is in the reprogrammable memory.

37. A module according to claim 36, wherein it is associated within a single box to an electrochemical supply source and at least one connector whereof the pins are linked with at least one interface of the module.

38. An application of the module according to claim 37 to the realization of symbol reading pen (1) support, the pen including in an optical sensor (2) a light source generating a light beam focused on the support and an optical detector intended to receive and convert the light reflected by the support into electric signals, the pen being stand-alone and including an internal electric power supply, the user application in the form of an operating programme including means for processing the electric signals of the optical detector and interfacing means via the radiocommunication module ensuring at least the transmission of said symbols according to said protocol to a data-processing equipment.

39. An application according to claim 38, wherein the symbols are barcodes.

40. An application according to claim 37 to the realization of a writing recognition reading pen, the pen including at least two accelerometers according to two axes X and Y corresponding to the writing plane and generating electric signals, the pen being stand-alone and including an internal electric power supply, the user application in the form of an operating programme including means for processing the electric signals and recognizing the writing, and interfacing means via the radiocommunication module ensuring at least the transmission of said writing according to said protocol to a data processing equipment.

41. An application according to claim 37 to the mains electric supply socket controlled by radiocommunication.

42. A method for reading, processing, transmitting and using a symbol on a support with a reading symbols pen according to claim 39, wherein:
the symbol is read with the pen,
said electric signals are processed in the interface module to generate digital and/or alpha-digital data,
said digital and/or alpha-digital data are associated with a reader identifier in order to generate a chain of corporate data, and
the chain of corporate data is transmitted in real time to at least one customer equipment including at least a software to carry out a command understandable by said customer equipment.

43. A method according to claim 42, wherein when a customer equipment is not available for reception, the chain of corporate data is stored in a memory of the reading pen.

44. A method according to claim 43, wherein in the customer equipment one associates moreover to the chain of corporate data at least one piece of data of customer equipment type in order to build a computer address depending then on the symbol, on the reader identifier and on the data of equipment type.

45. A method according to claim 44, wherein one implements a correspondence table in order to associate a computer address to the chain of corporate data, possibly associated with at least one piece of data of customer equipment type, the correspondence table being situated in a computer server distinct from the customer equipment.

46. A method according to claim 44, wherein one implements a correspondence table in order to associate a computer address with the chain of corporate data, possibly associated with at least one piece of data of customer equipment type, and that the correspondence table is stored in the customer equipment by selection according to a criterion in a global correspondence table situated in a computer server distinct from the customer equipment, the criterion including at least the reader identifier.

47. A method according to claim 46, wherein one encodes according to an encoding algorithm the digital and/or alpha-digital data before associating it with the reader identifier.

48. A method according to claim 46, wherein the computer address associated with the chain of corporate data is that of a computer server relaying an information request to another computer server.

49. A method according to claim 48, wherein the symbol is a barcode.

50. A method according to claim 49, wherein the support of the symbol is a display screen and that the symbols are barcodes corresponding to a successive temporal chaining of dark and clear surfaces on a display screen.

51. A method according to claim 33, wherein it includes, on the one hand, a radio printed circuit including a reprogrammable memory as well as means enabling reprogrammation of said memory on the basis of data received by radiocommunication.
